(19) United States
(12) Patent Application Publication
(10) Pub. No.: US 2009/0182444 A1
(43) Pub. Date: Jul. 16, 2009

(54) Audio-Visual Beer Keg System

(76) Inventor: Daniel Welch, Port Murray, NJ (US)

Correspondence Address: DIEHL SERVILLA LLC, 77 BRANT AVE, SUITE 210, CLARK, NJ, 07066, US

(21) Appl. No.: 11/972,873

(22) Filed: Jan. 11, 2008

(51) Int. Cl. G06F 17/00

(52) U.S. Cl. 700/94

(57) ABSTRACT

An audio-visual system having a media player, one or more output devices and a housing assembly resembling a beer keg is described. According to one or more embodiments, the media player includes an audio device or video device and the one or more output devices are speakers, displays or a combination thereof. In further embodiments, the media player is located on a moveable platform which moves in and out of the assembly. The assembly of some embodiments further includes one or more advertisements.

### TECHNICAL FIELD

Aspects of the present invention relate to audio-visual systems housed in or supported by assemblies resembling a beer keg.

### BACKGROUND

Parks, beaches, backyards and other such outdoor spaces are ideal locations for parties and events during the summer and all year areas with warm climates. However, transporting entertainment systems to these areas can be cumbersome. Further, the entertainment is often limited to systems which only play music. Additional considerations such as a constant and long-lasting power source must also be assessed when incorporating entertainment systems in outdoor areas.

Entertainment systems are also used in large events, such as outdoor concerts, festivals and sporting events. The potential for damage to costly entertainment systems at these large events is also a concern. Further such equipment may need to be large and of higher quality to provide high quality sound and therefore means for efficiently moving different parts of entire systems is needed.

The present invention provides for a complete entertainment system housed in a unique assembly which resembles a beer keg. The system provides audio and visual entertainment and includes speakers and/or displays. Further, the damageable components are hidden within a sturdy shell which can also include a means for easily gaining access to the components held within. The novelty of the housing can draw attention from large numbers of people and, therefore, can form an effective means for disseminating the advertising that is attached to some embodiments of the invention.

### SUMMARY

According to one aspect of the present invention, an audio-visual system is provided which includes an assembly housing a media player and at least one output device that is connected to the media player, wherein the assembly resembles a beer keg.

In one or more embodiments, the media player is an audio device such as a radio, a compact disc player, a cassette tape player, and a record player. Other embodiments utilize video devices such as video cassette players, high-density optical disc players. One or more embodiments further provide for media players including tuners such as analogue tuners, digital tuners, and Internet protocol tuners. At least one embodiment also provides for a media player capable of connecting to the Internet. Further embodiments of the media player of the present invention also incorporate recording and storage means and are capable of being controlled wirelessly.

Other embodiments utilize output devices such as speakers, displays or combinations thereof. In accordance with one or more embodiments, the audio-visual system further includes a power source.

According to another aspect of the invention, an external media source can also be utilized with the media player and/or output devices. Examples of external media sources include audio devices, video devices, video game console systems, televisions, and computers. In some embodiments, the external media sources are connected to the media player and can communicate with the media player. In further embodiments, the external media sources can also connect to the Internet.

In accordance with another aspect of the invention, the assembly resembling a beer keg has a side wall, a top end and a bottom end, which define an interior chamber. The side walls of these embodiments further include at least one opening. One or more embodiments of the present invention provide for the one or more output devices to be mounted to the openings in the side wall.

Another aspect of the invention includes a means for accessing the media player housed within the assembly by providing a moveable platform, having the media player attached thereto, located in the chamber of the assembly. Some embodiments include a means for moving the moveable platform. In other embodiments, the assembly has an opening or a mouth at the top end, through which the moveable platform can move in and out of the chamber. In other embodiments, the moveable platform further comprises a lid which encloses the mouth when the moveable platform is moved fully inside the chamber. One or more embodiments provide a wireless means for controlling the movement of the moveable platform.

In accordance with another aspect of the invention, one or more advertisements can be affixed to the exterior of the assembly.

Other aspects of the invention provide for the audio-visual system having a media player and at least one output device connected to the media player, placed on the top of an assembly resembling a beer keg. In some embodiments, some components of the media system can be housed within the assembly, while other parts remain affixed to the top of the assembly. In other embodiments, the output devices may be housed within the assembly, while the media player remains affixed to the top end of the assembly. In yet other embodiments, the media player can be housed within the assembly, while the output means are affixed to the outside of the assembly.

### BRIEF DESCRIPTION OF THE DRAWINGS

FIG. 1 shows an embodiment of the audio-visual system;

FIG. 2 shows the audio-visual system with a moveable platform according to another embodiment of the invention;

FIG. 3 illustrates a moveable platform within the chamber of an assembly according to one embodiment of the invention; and

FIG. 4 shows an embodiment of the invention in data communication with the Internet.

Before describing several exemplary embodiments of the invention, it is to be understood that the invention is not limited to the details of construction or process steps set forth in the following description. The invention is capable of other embodiments and of being practiced or being carried out in various ways.

### DETAILED DESCRIPTION

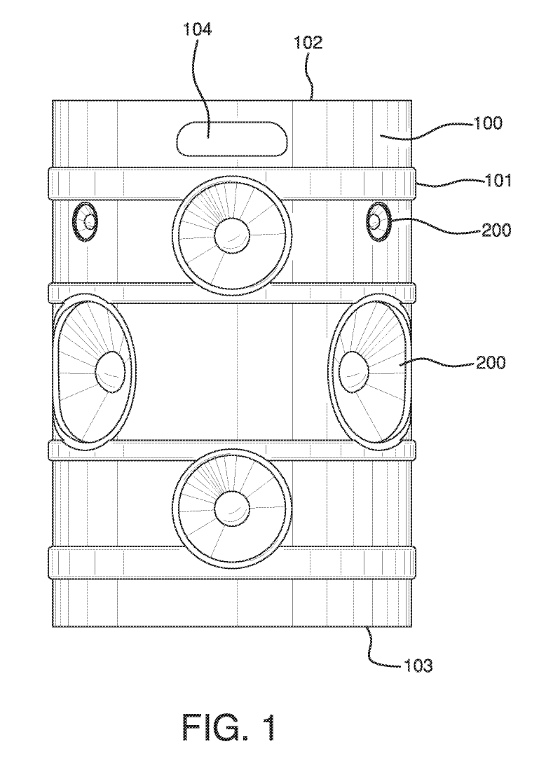

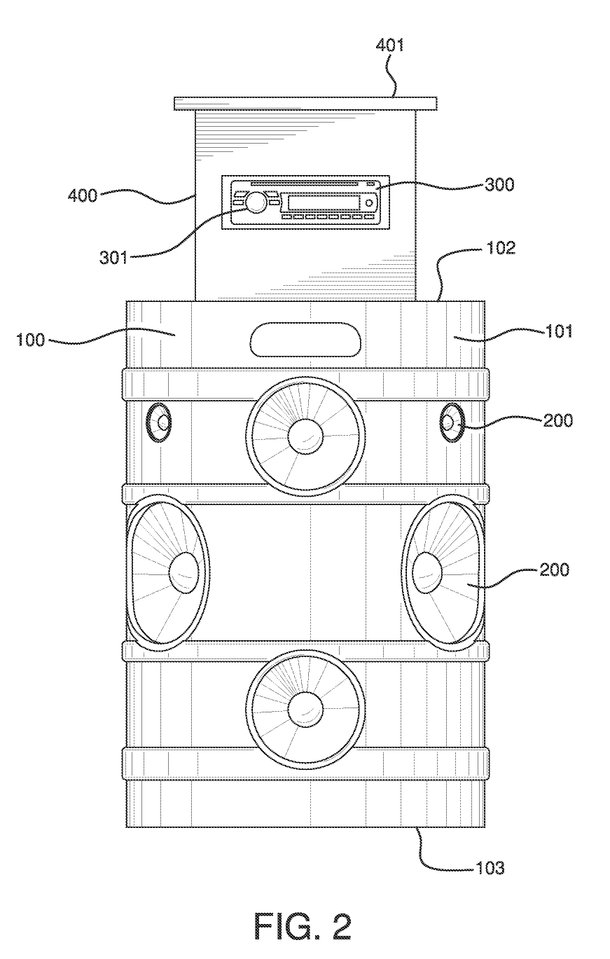

Referring to FIGS. 1 and 2, the audio-visual system includes a media player 300 and one or more output devices 200 connected thereto is housed within an assembly 100 resembling a beer keg. The assembly 100 has a top end 102, a bottom end 103 and at least one side wall 101 which define a chamber. In some embodiments, the assembly is constructed of metal, wood, plastic or a combination thereof. Further embodiments also include features commonly found on beer kegs such as spigots and one or more handles 104. In yet other embodiments, the assembly may also include a fully functional beer keg and may also, optionally, include beer within the beer keg. Additional embodiments may include a cooler or other cold storage. Some embodiments of the system include assemblies having larger dimensions and may include wheels or other means for moving the system affixed to the bottom end for moving the system. Further, these embodiments allow for storage of the wheels when not in use.

In accordance with one aspect of the invention, the media player is an audio device such as a radio, compact disc player, cassette tape player, record player, and any other device which can receive and process audio signals into sound. According to one embodiment, the media player can also include a tuner or other means for receiving multiple signals. In such embodiments, the tuner may be a digital tuner, an analogue tuner or an Internet protocol tuner. Some such embodiments may include tuners which can receive satellite signals.

Another aspect of the invention includes a video device such as a video cassette player, high-density optical disc player or other device which plays video files or signals known in the art. Other embodiments include a means for implementing software for playing video files.

In accordance with one aspect of the invention, the media player is in data communication with the Internet so that it may access files stored on the Internet. Further embodiments of the media player allow for the user to access the Internet, download, store and play audio, image and video files. As shown in FIG. 2, the media player can include a user interface 301. In other embodiments, the media player can be controlled wirelessly.

In accordance with one aspect of the invention, the audio-visual system can communicate with other such audio-systems, to create a network of audio-visual systems which can communicate with each other and/or a single audio-visual system. For example, one central audio-visual system according to an embodiment of the invention can control other audio-visual systems which may be embodiments of the present invention. In some instances, the other audio-visual systems could only function as displays or speakers, while in other instances, the other audio-visual systems could also function independently from the central audio-visual system.

The output devices of some embodiments are loud speakers, while other embodiments utilize displays, such as monitors and liquid crystal displays. Some embodiments utilize combinations of speakers and displays. In one or more embodiments, one or more crossovers are used with the output devices.

In accordance with another aspect of the invention, the audio-visual system comprises a power source. Some embodiments utilize power sources such as single-use batteries and/or rechargeable batteries while other embodiments rely on ac/dc power. Other embodiments utilize motors.

One aspect of the invention includes an audio-visual system further comprising an external media source. In some embodiments, the external media source is in data communication with the media player. Examples of external sources include an audio device, a video device, a video game console system, a television, and/or a computer. In some embodiments, the external media source has the capability of connecting to the Internet. Further embodiments have networking capabilities and are in data communication with one or more servers and/or computers.

In accordance with one or more aspects of the invention, a user interface is provided whereby the user can control the audio-visual system, including its individual components such as the media player and/or the one or more output devices. As otherwise discussed, the media player can also have a user interface. In other aspects of the invention, the user interface allows the user to control one or more functions of the audio-visual system. Non-limiting examples of functions include the on/off feature, volume, sound quality, display settings, connectivity the audio-visual system or its components to the Internet, connectivity of the media player to the one or more output devices, connectivity of the audio-visual system to other audio-visual systems, and connectivity of the audio-visual system to external media sources. According to one or more embodiments, the user interface may comprise keys, a touch screen or other interactive means. In other embodiments, a remote control or other wireless means is used to control the audio-visual system and/or its components.

According to one or more aspects of the invention, the one or more continuous side walls of the assembly have one or more openings. In further embodiments, the one or more output devices are affixed or mounted to the openings. In these embodiments, the output devices face outward so that the sound, image and/or images are emitted outside the chamber.

In accordance with one or more embodiments, the media player and/or the one or more output devices is housed outside of the chamber and assembly. The media player and/or the one or more output devices in some embodiments rest on the top end of the assembly. In other examples, the media player and/or the one or more output devices is affixed to the one or more side walls.

According to at least one aspect of the invention, the assembly includes a means for moving the media player in and out of the chamber. In one or more embodiments, the user can move the media player out of the chamber to access any user interface which may be affixed thereto or to change the media that is being played.

Referring to FIG. 2, the assembly can have an opening in the top end 104 or one of its side walls and a moveable platform 400 inside the chamber on which the media player 300 rests. The moveable platform can have a housing which encases the media player. This housing can also allow or restrict access to the interface. The moveable platform moves in and out of the chamber through the opening. Other embodiments provide for a moveable platform having enclosing walls which define a compartment in which the media player rests. In at least one embodiment, the moveable platform comprises a lid 401, which forms the upper enclosing wall. In such embodiments, when the moveable platform, is fully lowered into the chamber, the lid forms a closure for the opening in the assembly. In other embodiments, the opening has other closures such as a door or cover.

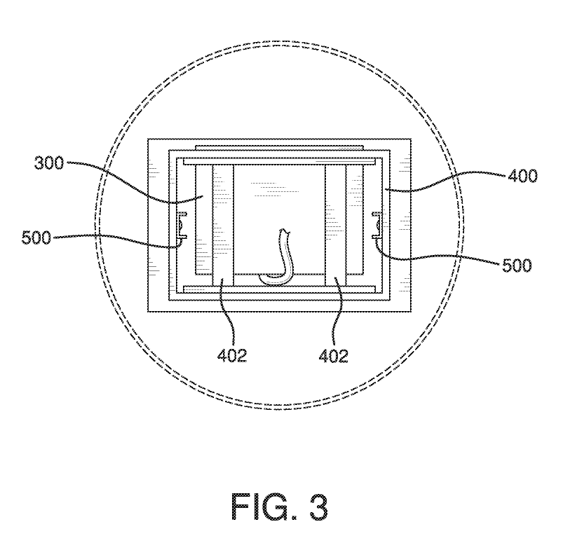

According to some embodiments, the moveable platform is moved by a mechanical arm. Referring now to FIG. 3, the moveable platform comprises a base 402 which supports the media player. The moveable platform may also be attached to one or more tracks 500 so that it slides in and out of the chamber. In one or more embodiments, a means for moving the moveable platform in and out of the chamber is used such as a linear actuator or one or more springs. Further embodiments incorporate guide rails or tracks in conjunction with such means.

At least one embodiment also includes a means for the user to control the movement of the chamber. In some instances, the user can manually pull the moveable platform out of the chamber. In other instances, a user interface provides a means for controlling the moveable platform. Yet other embodiments provide a remote control for controlling the moveable platform wirelessly.

According to one or more embodiments, the means for moving the moveable platform can further include a power source. In a specific embodiment, the power source used to move the moveable platform is separate from the power source used with the audio-visual system. In a more specific embodiment, the moveable platform utilizes the same power source used by the audio-visual system and/or the media player.

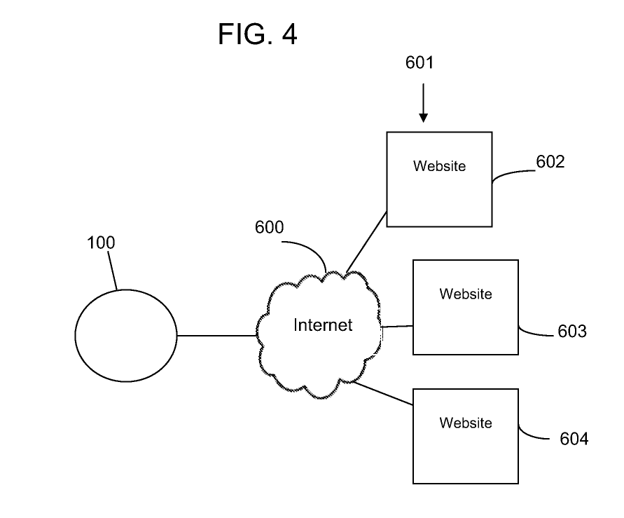

Referring to FIG. 4, the assembly 100 is in data communication with the Internet 600, through which the assembly can access various websites 601. In one embodiment, the websites can be maintained to download music to the assembly 100. The websites 602, 603 of another embodiment, further maintains selectable types or genres of music, such as rock, rap or pop available for downloading to the device 100. The websites 604 can also be maintained to allow users to play video games on the Internet using the assembly 100 or to download video games to the assembly 100 in further embodiments.

In accordance with one aspect of the invention, the exterior surface of the assembly includes at least one advertisement. In some embodiments, the advertisements may be removeably attached to the exterior surface. In other embodiments, the advertisements may be permanently affixed to the exterior surface. For example, some advertisements may be integrally molded to the exterior surface of the assembly. In some instances, the advertisements may be displayed or played on the one or more output devices. In other instances, the advertisements may include, without limitation, signs, logos, trademarks, images, and/or scrolling messages.

Reference throughout this specification to “one embodiment,” “certain embodiments,” “one or more embodiments” or “an embodiment” means that a particular feature, structure, material, or characteristic described in connection with the embodiment is included in at least one embodiment of the invention. Thus, the appearances of the phrases such as “in one or more embodiments,” “in certain embodiments,” “in one embodiment” or “in an embodiment” in various places throughout this specification are not necessarily referring to the same embodiment of the invention. Furthermore, the particular features, structures, materials, or characteristics may be combined in any suitable manner in one or more embodiments.

Although the invention herein has been described with reference to particular embodiments, it is to be understood that these embodiments are merely illustrative of the principles and applications of the present invention. It will be apparent to those skilled in the art that various modifications and variations can be made to the method and apparatus of the present invention without departing from the spirit and scope of the invention. Thus, it is intended that the present invention include modifications and variations that are within the scope of the appended claims and their equivalents.

What is claimed is:

1. A audio-visual system comprising:
a media player;
one or more output devices connected to the media player; and
an assembly resembling a beer keg housing the media player and the one or more output devices.

2. The system of claim 1, wherein the media player is an audio device and the one or more output devices are speakers.

3. The system of claim 1, wherein the media player is a video device and the one or more output devices includes a display.

4. The system of clam 3, wherein the one or more output devices further includes one or more speakers.

5. The system of claim 1 further comprising a power source.

6. The system of claim 2, wherein the audio device is selected from a group consisting of a radio, a compact disc player, a cassette tape player, and a record player.

7. The system of claim 3, wherein the video device is selected from a group consisting of a video cassette player and a high-density optical disc player.

8. The system of claim 1, wherein the media player further comprises at least one tuner, wherein the at least one tuner is selected from a group consisting of an analogue tuner, a digital tuner, and an Internet protocol tuner.

9. The system of claim 1, wherein the media player is in data communication with the Internet.

10. The system of claim 1, wherein the media player further comprises a recording means and storage means whereby sound, video and image files can be recorded and stored.

11. The system of claim 1, wherein the media player is controlled wirelessly.

12. The system of claim 1, wherein the media player further comprises at least one tuner, wherein the at least one tuner is selected from a group consisting of an analogue tuner, a digital tuner, and an Internet protocol tuner.

13. The system of claim 1 further comprising at least one external media source, wherein the at least one external media source is in data communication with the media player.

14. The system of claim 13, wherein the external media source is an audio device, a video device, a video game console system, a television, or a computer.

15. The system of claim 1, wherein the assembly further comprises a top end, a bottom end, and a side wall having one or more openings defining an interior chamber.

16. The system of claim 15, wherein the one or more output devices are affixed to the one or more openings in the side wall of the assembly.

17. The system of claim 15, wherein the assembly further comprises
a moveable platform located within the chamber;
a lid attached to the moveable platform;
an mouth at the top end of the assembly;
a means for moving the platform in and out of the chamber through the mouth,
wherein the lid forms a closure for the mouth when the moveable platform is moved fully into the chamber.

18. The system of claim 17, wherein the means for moving the moveable platform is controlled wirelessly.

19. The system of claim 17, wherein the media player is affixed to the moveable platform.

20. The system of claim 1, wherein the assembly comprises one or more advertisements.
